(19) United States
(12) Patent Application Publication
(10) Pub. No.: US 2016/0316330 A1
(43) Pub. Date: Oct. 27, 2016

(54) METHOD AND DEVICE FOR BUSINESS AND PRIVATE REGION SEPARATION

(71) Applicant: BEIJING QIHOO TECHNOLOGY COMPANY LIMITED, Beijing (CN)

(72) Inventors: Li WANG, Beijing (CN); Pengcheng WANG, Beijing (CN); Xuan LI, Beijing (CN); Yunlin SU, Beijing (CN); Wei LIU, Beijing (CN)

(73) Assignee: BEIJING QIHOO TECHNOLOGY COMPANY LIMITED, Beijing (CN)

(21) Appl. No.: 15/103,531

(22) PCT Filed: Sep. 30, 2014
(86) PCT No.: PCT/CN2014/087815

§ 371 Date: Jun. 10, 2016

(30) Foreign Application Priority Data
Dec. 10, 2013 (CN) 201310666504.2
Dec. 20, 2013 (CN) 201310713538.2

(51) Int. Cl. H04W 4/02; G06F 21/60; H04L 29/08

(52) U.S. Cl. CPC H04W 4/021; H04L 67/10; G06F 21/602; H04W 4/14

(57) ABSTRACT

Disclosed are method and device for business and private region separation, comprising: monitoring a system event of a mobile terminal and determining whether the system event satisfies a preset work region rule; and when the system event satisfies the work region rule, executing an operation corresponding to the system event in a work region space, and encrypting and storing data corresponding to the operation in a database of the work region space. In the method and device for business and private region separation according to the disclosure, a safe and independent work region is established in the mobile terminal to store all work data in a protected security region. Therefore, individual application cannot visit enterprise data, preventing the enterprise data from an illegal access by the individual application. IT department is allowed to better protect enterprise application and data, while staff can be provided with undifferentiated personal application experience, achieving “one machine dual purposes” effect.

### CROSS-REFERENCE TO RELATED APPLICATIONS

This application is the national stage of International Application No. PCT/CN2014/087815 filed Sep. 30, 2014, which is based upon and claims priority to Chinese Patent Applications No. CN201310666504.2 filed Dec. 10, 2013 and CN201310713538.2, filed Dec. 20, 2013, the entire contents of which are incorporated herein by reference.

### FIELD OF TECHNOLOGY

The disclosure relates the field of network security technologies, and in particular to a method and device for business and private region separation.

### BACKGROUND

With the maturity and popularity of smart terminals, personal smart terminal equipment represented by mobile phone and tablet have gradually entered into enterprise. According to a prediction of authoritative international consulting firm, by 2014, 90% of companies would support staffs to run office applications of enterprise on their personal mobile terminals. Handling of official business by using staffs' personal smart terminal equipment has become an irreversible trend. Such a phenomenon known as BYOD (Bring Your Own Device) has brought new challenges to security and management for the enterprise. The staffs' mobile devices may access to Mobile Internet or public/family Wi-Fi (Wireless-Fidelity) network at any time any place. The enterprise data in the mobile terminals may also be exposed to attacks from the Internet. BYOD breaks a boundary of original enterprise network. It is the ambiguity of this boundary that causes the BYOD to be a weak link of enterprise information security system. There is a need for a new method to protect the security of enterprise data.

Both personal application data and enterprise application data may exist in the same mobile terminal. The personal application may freely visit and access to enterprise data, so that there is a risk that personal applications may illegally upload, share and leak out the enterprise data. For example, as for office emails, files, pictures, communication records and business content-related text messages which are stored in the mobile phone, the leakage of these kinds of sensitive information may bring a great information security risk to the enterprise. The mobile equipment are possibly lost. Therefore, the sensitive data of the enterprise stored in the mobile equipment may be confronted with a leakage risk. Lost equipment may possibly become a springboard to attack the enterprise network. According to the National Internet Emergency Center statistics, the newly discovered malicious programs exceeded 160,000 in 2012 with an increase of 25 times over 2011. In first half of 2013, Android mobile phone virus sharply went up about 8 times. In the meanwhile, due to abuse of Root authority (super user authority) and new hacking techniques, the mobile terminals may possibly become a springboard for a hacker to invade the inner network of the enterprise.

### SUMMARY

In the view of above problems, the technical problems to be addressed by the disclosure are to provide a method and a device for business and private region separation, which provides a work region in the mobile terminal to complete relevant operations.

A method for business and private region separation comprises steps of: monitoring a system event of a mobile terminal and determining whether the system event satisfies a preset work region rule; and when the system event satisfies the work region rule, executing an operation corresponding to the system event in a work region space, and encrypting and storing data corresponding to the operation in a database of the work region space.

A device for business and private region separation comprises: an event monitoring module, configured to monitor a system event of a mobile terminal and determine whether the system event satisfies a preset work region rule; and an execution module, configured to, when the system event satisfies the work region rule, execute an operation corresponding to the system event in a work region space, encrypt and store data corresponding to the operation in the database of work region space.

The method and device for business and private region separation according to the disclosure can establish a safe and independent work region in the mobile terminal to store all the work data (i.e., enterprise application and data) in a protected security region without interfering with use experience of individual application of staff. An individual application cannot visit the enterprise data, preventing the enterprise data from an illegal access by the individual application. Not only could the enterprise data be completely separated from individual data so as to allow the IT department to better protect the enterprise application and data, but also the staff can be provided with undifferentiated personal application experience, achieving a “one machine dual purposes” effect.

### BRIEF DESCRIPTION OF THE DRAWINGS

In order to more apparently describe the technical schemes in the embodiments of the disclosure or in the prior art, accompanying figures necessarily used in the description of the embodiments or the prior art will be simply explained hereinafter. Obviously, the accompanying figures described below will form the embodiments of the disclosure. An ordinary person skilled in the art may conceive further figures in accordance with these accompanying figures without contributing creative labor.

FIG. 1 is a flowchart of a method for business and private region separation according to an embodiment of the disclosure;

FIG. 2 is a flowchart of an embodiment of processing on phone calls and text messages in the method for business and private region separation according to the disclosure;

FIG. 3 is a flowchart of another embodiment of processing on phone calls and text messages in the method for business and private region separation according to the disclosure;

FIG. 4 is a schematic diagram of a device for business and private region separation according to an embodiment of the disclosure;

FIG. 5 is a schematic diagram of an interaction with enterprise network information by the device for business and private region separation according to the embodiment of the disclosure;

FIG. 6 schematically illustrates a block diagram of a computing device for executing the methods according the disclosure; and

FIG. 7 schematically illustrates a memory cell which is used to store or carry program codes for realizing the methods according to the disclosure.

### DESCRIPTION OF THE EMBODIMENTS

Hereinafter the disclosure will be more comprehensively described with reference to the accompanying figures wherein the exemplary embodiments thereof will be explained. The technical schemes in the embodiments of the disclosure will be thoroughly and completely described below in conjunction with the accompanying figures therein. It is obvious that the embodiments described herein are merely some of embodiments of the disclosure rather than entire embodiments. On the basis of the embodiments of the disclosure, other embodiments conceived by an ordinary person skilled in the art without creative labor would fall into the scope of the disclosure.

By establishing a strict a work region or work region on a mobile terminal, the method for business and private region separation according to the disclosure could ensure the security of data and applications at work on the mobile terminal through various means such as encryption and monitoring. Corresponding to the work region, there is a personal region in the mobile terminal for storing data irrelevant to working.

Herein, in the embodiment of the disclosure, the work region and the personal region may be defined as follows: in the use of the device, for the purpose of easily managing personal materials and working materials in the device, a portion of memory space of a disk can be divided in the device, with new authority information configured, can be used to store and manage the working materials, and this portion of memory space of the disk can be called as a work region; and the remaining portion of memory space of the disk in the device can be used to store and manage the personal materials or other materials, the remaining portion of memory space can possess initial authority information, and this portion of memory space of the disk can be called as a personal region.

Furthermore, in order to facilitate operations, the personal region and the work region may have different UI (User Interface) but share some of system files.

### First Embodiment

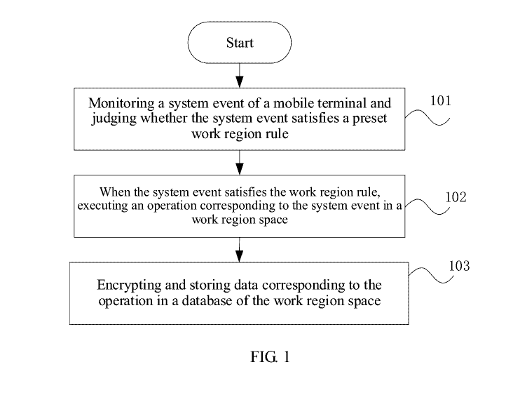

FIG. 1 is a flowchart of a method for business and private region separation according to an embodiment of the disclosure.

FIG. 1 shows, Step 101, monitoring a system event of a mobile terminal and determining whether the system event satisfies a preset work region rule;

Step 102, when the system event satisfies the work region rule, executing an operation corresponding to the system event in a work region space; and

Step 103, encrypting and storing data corresponding to the operation in a database of the work region space.

In this embodiment, the so-called business and private region separation means that business-related data and private data of a user are separated, wherein, as the mobile terminal, for example, a game console, a laptop, a portable media player, a Pad, a tablet, a PDA, a mobile computer and a mobile phone.

Herein, the mobile terminal may be input by means of a slide input, gesture input, touch input and voice input.

In this embodiment, the database of the work region space is a database provided independently with respect to original database in the mobile terminal or with respect to databases of a variety of applications in the mobile terminal and used to store data for the work region. Region space is resources of the mobile terminal (memory and memory card, etc.) and logic operating space divided by the user. The work region rule can be configured on the basis of key words in contacts and text messages.

Encrypted data of the work region space may be stored in the database of the work region space or in a storage device of the mobile terminal. The encrypted data may relate to data inside system files or data inside financial files, production files, sales files, marketing files and human resource files selected by the user. The encrypted data may also be data of the user's personal files, such as photos, videos and logs.

According to one example of the disclosure, the user enters the work region to perform business (enterprise) related operations, such as editing schedule, sending text messages, writing mails, downloading statements or taking pictures. The data parallel to working operations, such as schedule, pictures, mails, statements and text messages can be encrypted and stored in the database of the work region space, while the operation data irrelevant to working can be stored in the work region space, such as a public space of the mobile terminal, such that the business data and private data can be separated. By encrypting data, other applications in the mobile terminal cannot use the data even though obtain it.

When the user views the data stored in the database of the work region space, he or she would be required to input a password. When the mobile terminal is lost, since the user has set the password to view the work region data (this function could be set according to the user's habit and willing). The work region data cannot be displayed without knowing the user's password. Alternatively, an enterprise management server may remotely operate to invoke the applications of the work region in the mobile terminal and to delete the work region data stored in the mobile terminal. Therefore, the data of the enterprise can be kept in security.

### Second Embodiment

In this embodiment of the disclosure, the system event may include a phone call event and a text message event, wherein the phone call event may include: an incoming call event and a making-call event, wherein the incoming call event may include a received-call event and a missed-call event; the text message event may include a receiving text message event and a sending text message event. Therefore, the work region rule of the phone call event may be configured such that contacts of the phone call event are stored in the database of the work region space, and the work region rule of the text message event may be configured such that contacts of the text messages are stored in the database of the work region space. Herein, information of the contacts may include a phone number MSISDN (Mobile Subscriber International ISDN/PSTN Number) of a calling party or a called party in the phone call event, and MSISDN of a recipient or a sender of a text message in the text message event.

Upon the detection of above events, relevant operations can be executed in accordance with the specific system event. Hereinafter a specific method for business and private region separation will be discussed by way of an example.

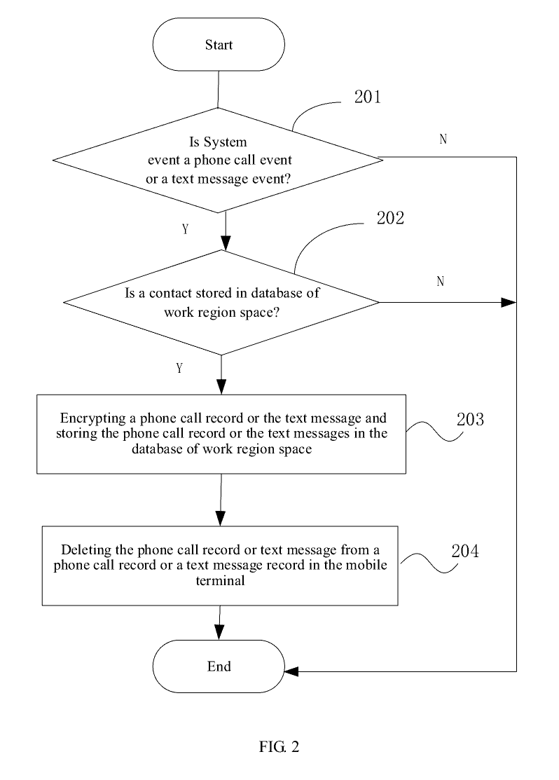

FIG. 2 is a flowchart of an embodiment of processing on phone calls and text messages in the method for business and private region separation according to the disclosure.

FIG. 2 shows, Step 201, determining whether a system event is a phone call event and text message event;

Step 202, determining whether a contact is stored in database of work region space.

Step 203, when a phone number of a calling party or called party of the phone call, or a phone number of a sender or recipient of the text message is stored in the database of work region space, encrypting a phone call record or the text message and storing the phone call record or the text messages in the database of work region space.

Step 204, deleting the phone call record or text message from a phone call record or a text message record in the mobile terminal.

Therefore, when the system event is the phone call event, satisfaction of the work region rule can be determined by detecting whether the phone number of a calling party or called party in the phone call event is stored in the database of work region space. If yes, that is, the phone number is stored in the database of work region space, then the work region rule is satisfied; otherwise the work region rule is not satisfied. Thus the phone call can be made in the work region space. For example, the database of work region space is searched for the contact to make a call. As another example, the work region space is searched for the phone call record about missed calls. Then the data corresponding to the phone call event such as records of incoming calls, making calls or missed calls are encrypted and stored in the database of work region space. In addition, a record of the phone call event can be removed from the phone call record of the mobile terminal. In this embodiment of the disclosure, the phone call record and text message record of the mobile terminal refers to the phone call record and the text message record of non-work region (i.e., personal region).

The text message event is similar to the phone call event. When the phone number of a sender or recipient in the text message event is stored in the database of work region space, then the work region rule is satisfied; otherwise the work region rule is not satisfied. Then operations relevant to the text message event may be executed in the work region space. For example, the text message is edited and viewed in the work region space. Then the text message is encrypted and stored in the database of work region space. Record information relevant to the text message (such as, sending record and receiving record) may also be encrypted and stored in the database of work region space. Further, the text message may also be removed from the text message record of the mobile terminal.

In this embodiment of the disclosure, there may be also provided an option interface for phone calls, through which the user may choose whether to delete the phone call record of the mobile terminal when calling party MSISDN or called party MSISDN of the phone call event is stored in the database of work region space. In such a manner, the user can set in accordance with his or her habit to improve user's satisfaction.

By above process, business phone calls and emails can be separated from private phone calls and emails, so as to ensure the security of business information.

In this embodiment of the disclosure, the system event may include a phone call event and a text message event, wherein the phone call event may include a received-call event, a making-call event and a missed-call event; the text message time may include a receiving text message event and a sending text message event. Based on above system event, an optional method for business and private region separation will be described in detail.

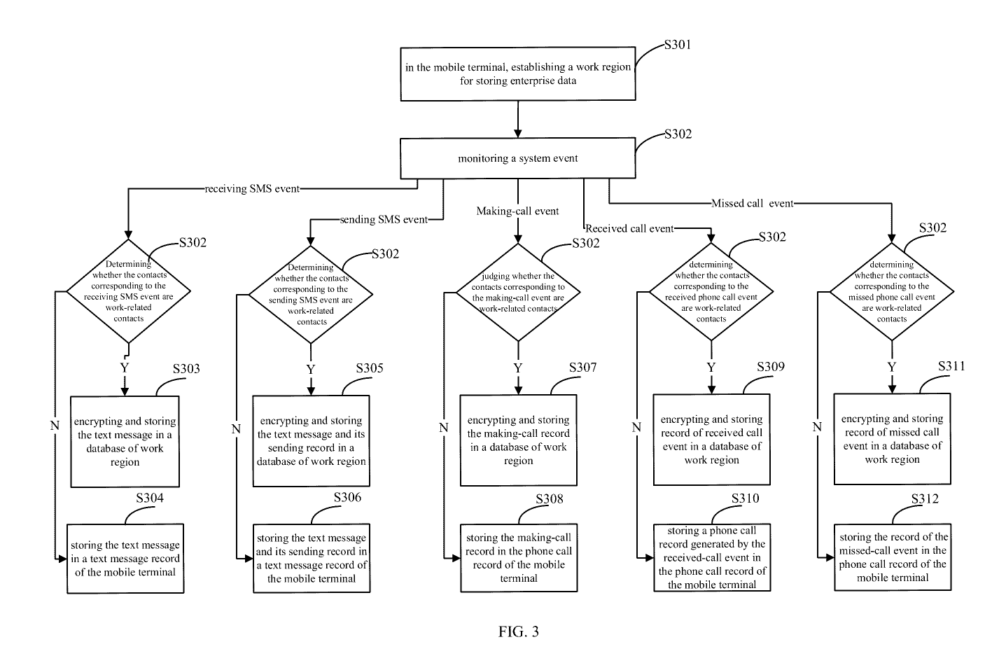

FIG. 3 is a flowchart of another embodiment of processing on phone calls and text messages in the method for business and private region separation according to the disclosure. The method may include Step S301 to Step S312.

Step S301, in the mobile terminal, establishing a work region for storing enterprise data.

Herein, the work region is established for storing the data generated at work to separately store the data in the work region and the data in the personal region (i.e., achieve business and private region separation), thereby managing the data in the work region. In order to ensure the security of the data in work region, the data in work region can be saved in an encrypted manner. The user may set an unlock code for the data in work region. When the user inputs a correct unlock code, he or she is allowed to access to the data in work region.

Taking Android system as an example, when the data in work region is set with the unlock code and separately stored, a following manner could be employed: creating and recording Launchers of user's personal region and work region, respectively, and prompting the user to input a password to login in front of desktop. If the user input a correct password to login the work region legally, then a Launcher of work region could be activated to provide a desktop of work region for the user. The user may visit the applications in the work region via the desktop. If the user does not login, then a default Launcher of personal region is selected to activate. The user may visit the applications in the personal region via the default Launcher. As a result, the separation of the work region from the personal region can be completed. Herein the Launcher is a launcher or desktop in Android system, and other applications can be visited via icons on the desktop.

Step S302, monitoring a system event and determining whether the system event satisfies a work region rule.

Herein, if the system event satisfies a work region rule, operations corresponding to the event may be executed in the work region. If the system event does not satisfy the work region rule, operations corresponding to the system event may be executed in the personal region.

In this embodiment, in order to better manage the data in work region, the mobile terminal is provided with address books for storing information of contacts. Herein one or more address book may be provided. Taking two address books as an example, one is provided as an enterprise address book for business, while the other one is provided as a private address book for the user. Contact information such as phone numbers, email accounts and instant messaging accounts of the contacts can be stored in the address books.

Herein, the enterprise address book is provided in the work region, and business related contacts of the user are stored in the enterprise address book. For example, the contacts included in the enterprise address book may be all colleagues of a department where the user serves, and the enterprise address book may also include clients of the user. In addition, in order to easily manage and update the enterprise address book, the enterprise address book may also be synchronized with a server. In other words, the user's enterprise address book may be synchronously updated in accordance with the server at the regular time. For example, a new contact added by an administrator of the enterprise address book may be updated into the user's enterprise address book. It should be explained that users who serve in the same department usually face different work-related contacts. For example, a user “A” who serves in administration department may closely cooperate with personnel department, while a user “B” who also serves in administration department may closely cooperate with international department. Usually, the contacts synchronized with the server are only common work-related contacts of the department, without completely covering work-related contacts of each colleague. According to this embodiment, in order to satisfy requirements of different users, in the work region, contacts introduced by the user may also be stored in above enterprise address book. These contacts could be ones who closely cooperate with the user but do not serve in this department, such as clients as stated above. The settings of introducing individual contacts may allow different users to set the contacts in work region in accordance with their own requirements, thereby facilitating the user's operations while ensuring the security of the enterprise data.

Unlike the address books in the work region as described above, the private address book is provided in non-work region, including the contacts in relation to the individual user, such as relatives and friends. However, the contacts in work region may be overlapped with the contacts in the user's private address book. For example, a contact “A” could be not only the user's colleague but also the user's friend. Then the contact “A” could be stored in both the enterprise address book and the private address book, so as to ensure the security of the enterprise data.

Since there are various system events in this embodiment, the system events are monitored at Step S302 as described above and operations of the step can be executed in accordance with different system event. Detailed process thereof may be as follows.

The system events are monitored to determine whether the contacts corresponding to the system event are work-related contacts. When they are work-related contacts, the satisfaction with the work region rule can be determined. At this point, relevant operations may be executed in the work region according to a type of the system event, such as editing text messages, viewing text messages, and viewing missed calls. When they are not work-related contacts, the dissatisfaction with the work region rule can be determined. At this point, relevant operations may be executed in the non-work region according to a type of the system event.

Herein, the work-related contacts are those contacts assigned into the enterprise address book by above enterprise or introduced into the address book of the work region by the individual user. In other words, information of these contacts is stored in the database of work region space.

Detailed process of the method in the case of above five system events will be explained below.

In the first case, the system event is a receiving text message event.

When the system event is the receiving text message event and the contacts in relation to the receiving text message event are determined to be the work-related contacts at Step S302, the process will go to Step S303; otherwise go to Step S304.

Step S303, blocking a text message from entering the text message record of the mobile terminal, viewing the text message at the work region space, and encrypting the text message to store it in a database of work region.

Step S304, storing the text message in a text message record of the mobile terminal.

At Step S303, the text message is blocked from entering an inbox of the text message record of the mobile terminal (i.e., location where the text message is stored in the non-work region), and the text message is encrypted to store it in the work region, thereby achieving the business and private region data separation, avoiding malicious view of the work-related messages in the user's system inbox, and ensuring the security of the enterprise data.

In the second case, the system event is a sending text message event.

When the system event is the sending text message event, whether the contacts in relation to the sending text message event are the work-related contacts may be determined at Step S302. If they are the work-related contacts, then the process will go to Step S305; if they are not work-related contacts, then the process will go to Step S306.

Step S305, blocking a text message and a sending record thereof from a text message record of the mobile terminal, editing the text message at the work region space, and encrypting the text message and the sending record thereof to store it in a database of work region space.

Step S306, storing the text message and the sending record thereof in the text message record of the mobile terminal.

At Step S305 the text message and the sending record thereof are blocked from entering a box of the text message record of the mobile terminal, and the text message and the sending record thereof are encrypted to store it in the work region, thereby achieving the business and private region data separation, avoiding malicious view of the work-related messages in the user's system outbox, and ensuring the security of the enterprise data.

In the third case, the system event is a making-call event.

When the system event is the making-call event, whether the contacts in relation to the making-call event are the work-related contacts may be determined at Step S302. If they are the work-related contacts, then the process will go to Step S307; if they are not work-related contacts, then the process will go to Step S308.

Step S307, encrypting a making-call record to store it in a database of work region space.

Step S308, storing the making-call record in the phone call record of the mobile terminal.

It should be explained that in order to allow the user to easily view the making-call record, before storing the making-call record at Step S307, it may also include following process: determining whether the user has set to display phone call record of the work-related contacts in the phone call record of the operating system. When the user does not set to display phone call record of the work-related contacts in the phone call record of the operating system, before storing the making-call record at Step S307, it is possible to delete the making-call record from the phone call record of the mobile terminal or block the making-call record from entering the phone call record of the mobile terminal. When the user sets to display phone call record of the work-related contacts in the phone call record of the operating system, then it is possible to display the making-call record in the phone call record of the mobile terminal while storing it in the database of work region space. Further, in this embodiment, as required, the user may set whether the phone call record of each contact in the work region is displayed in the phone call record of the system. As an alternative, the user may set uniformly. That is, the user may set all the phone call records to be displayed in the phone call record of the system or none of the phone call records to be displayed in the phone call record of the system.

In the fourth case, the system event is a received-call event.

When the system event is the received-call event, whether the contacts in relation to the received-call event are the work-related contacts may be determined at Step S302. If they are the work-related contacts, then the process will go to Step S309; if they are not work-related contacts, then the process will go to Step S310.

Step S309, storing a record of a received-call event in a database of work region space.

Herein, for the monitoring of the system events and the removal of records from the phone call record or the text message record, different operating systems in the mobile terminals may employ different means, and thus operating manners may be determined on the basis of different types of operating systems.

For example, the operating system is Android. First, making-call broadcast monitoring is registered. An OutCallReceiver may obtain a dial-out number and then determine whether it is a contact stored in the database of work region space. If yes, then the phone call record will be deleted from an incoming call record of the mobile terminal. The monitoring manner of system's incoming calls or making calls may mainly include: TelephonyManager.listen( ) (monitoring an incoming call state).

As another example, in Android system, when the system event is the making-call event or the incoming call event, a following manner may be used to maintain (copy and move) the phone call record of the operating system: the making-call event and the incoming call event is received by a broadcast receiver known as PhoneStateReceiver; in the case of the making-call event or the incoming call event, a service known as CallLogObserverService is activated to maintain the phone call record, inclusive of copy and move operations of the phone call record. Herein, the broadcast receiver PhoneStateReceiver may ensure to activate the service CallLogObserverService when the phone call event occurs and to complete through a service startService provided by the operating system. The event in which the broadcast receiver PhoneStateReceiver receives making-call and receiving-call may be achieved by following codes:

```
<intent-filter>
      <action android:name=
      “android.intent.action.PHONE_STATE” />
      <action android:name=
      “android.intent.action.NEW_OUTGOING_CALL” />
</intent-filter>
```

In particular, before the service CallLogObserverService is activated, it is also required to obtain a read-write privilege of the address book of the operating system by stating used privileges in androidmanifest.xml:

<uses-permission android:name=“android.permission.READ_PHONE_STATE”/>

Herein, the copying of the phone call record may be completed by a service CallLogObserverService. A monitoring service ContentObserver and a Handler for handling changes are registered in the process of activating the service CallLogObserverService; the monitoring service ContentObserver is used to monitor the changes in the phone call record database of the system (its URI is android.provider.CallLog.Calls.CONTENT_URI). When there is a change in the phone call record, an onChange method of the Handler is invoked to update the phone call record database in work region.

Step S310, storing a phone call record generated by the received-call event in the phone call record of the mobile terminal.

Herein, when the work-related contacts of the incoming call event are also contacts in a private address book, before storing the record of incoming call event at Step S309, the process may include following operations: prompting the user whether to store the record of the received-call event in the phone call record of the mobile terminal. When the user selects “No”, at Step S309, the phone call record generated by this received-call event may be deleted from the phone call record of the mobile terminal or blocked from entering the phone call record of the mobile terminal. When the user selects “Yes”, then the record of this received-call event may be stored in the phone call record of the mobile terminal, and then the record of the received-call event may be encrypted to store it in the database of work region space. Above operation prompt to the user is able to save or delete the phone call record according to different requirement of the user, so as to facilitate user's operation while ensuring the security of the work region data.

In the fifth case, the system event is a missed-call event.

When the system event is the missed-call event, whether the contacts in relation to the missed-call event are work-related contacts may be determined at Step S302. If they are the work-related contacts, then the process will go to Step S311; if they are not work-related contacts, then the process will go to Step S312.

Step S311, storing a record of the missed-call event in a database of work region space.

Step S312, storing the record of the missed-call event in the phone call record of the mobile terminal.

It should be explained that when MSISDN (i.e., MSISDN of work-related contacts) of the missed-call event is overlapped with the MSISDN of contacts in the private address book, before storing the record of missed-call event at Step S311, the process may further include: prompting the user whether to store the record of the missed-call event in the phone call record of the mobile terminal. When the user selects “No”, at Step S311 the record of the missed-call event may be deleted from the phone call record of the mobile terminal or the record of the missed-call event may be blocked from entering the phone call record of the mobile terminal. When the user selects “Yes”, then the record of this missed-call event may be stored in the phone call record of the mobile terminal.

It should be explained that the five system events as described above in this embodiment are merely illustrative rather than intended to restrict the scope for which protection is sought by the embodiments of the disclosure. Other system events supportable by the mobile terminal will fall within the protection scope of the embodiments of the disclosure.

In the embodiments of the disclosure, the work region is established in the mobile terminal to store the enterprise data in an encrypted manner, and in the meanwhile the system events are monitored; when the work region rule is satisfied, then operations corresponding to the event may be executed in the work region. As could be seen, the method provided in the embodiments of the disclosure may avoid the leakage of the enterprise data due to attacks of malicious programs. Even though the mobile terminal is lost, the third party could not read the enterprise data since the work region is encrypted. Thereby the enterprise data can be kept in security and away from the malicious programs.

### Third Embodiment

In this embodiment of the disclosure, the system event may further include an email event. Then the work region rule of the email event may be configured such that an email account of a sender or recipient of an email is stored in the database of work region space. Therefore, according to an example of the disclosure, an option interface of email rule may be provided such that the user can set to receive an email account only in the work region or using a work region application, and store the email account in the database of work region space so as to separate the business email data from the private email data.

When the system event is determined to be receiving-email and the email account of the sender is stored in the database of work region space, the system event may satisfy the work region rule. Therefore, operations in relation to the email event, such as editing email, viewing email, downloading attachment and uploading attachment, can be executed in the work region space. Further, content of the email and downloaded email attachment can be encrypted and then stored in the database of work region space.

In this embodiment of the disclosure, the enterprise address book assigned by the user in the database of work region space may store a variety of information about the work-related contacts, including: MSISDN of mobile phone number, telephone number, and email account, for example. It may be determined whether the calling party MSISDN or called party MSISDN in the phone call event, or the sender MSISDN or recipient MSISDN in the text message event, or the sender email account or recipient email account in the email event is stored in the enterprise address book. If yes, then the data such as phone call record, text message and email corresponding to the system event may be encrypted and stored in the database of work region space.

Since the work region has a relatively high requirement on data confidentiality, a password can be assigned to lock the work region. After the password inputted by the user is successfully verified, the work region may be unlocked to allow the use to enter the work region to view the phone call records, the text messages, the emails or the email attachments. The phone call records, the text messages, the emails or the email attachments stored in the database of work region space may be decrypted for the user to view them.

Since some of email attachments are opened necessarily by third party software, when the user is determined to finish viewing, temporary files which are generated by decrypting the phone call records, the text messages, the emails or the email attachments and which are opened by the third party software are deleted. When the user closes a browser, cache of the browser can be cleaned up.

According to this embodiment of the disclosure, when the work region data is encrypted, a variety of encryption algorithms can be employed. For example, the encryption algorithm for encrypting the phone call records, the text messages, the emails or the email attachments could be AES256 encryption algorithm.

According to one example of the disclosure, a work region application is allowed to be operated in the mobile terminal and enter the work region, the option interface of contacts is provided for the user, the user selects the work-related contacts from the contacts in the mobile terminal address book, and then the work-related contacts selected by the user are stored in the database of work region space, thereby allowing the user easily set the work-related contacts.

Reception server side (for example, a business administration platform of enterprise) may send work region strategy and rule and store the work region strategy and rule in the database of the work region. In accordance with the work region strategy and rule, it is possible to conveniently update the work region application or update strategy and regulation in the mobile terminal.

According to one example of the disclosure, the mobile terminal may send, for example, financial files, production files, sales files, marketing files, human resource files to the business administration platform, receive a processing result of the business administration platform and store it in an encrypted manner.

According to one example of the disclosure, the monitoring of the system events of the mobile terminal and the deletion of the records from the mobile terminal can be set according to different operating systems. For example, the operating system in the mobile terminal is Android system.

Once the work region application logins, an original default Launcher (desktop launcher in Android system; desktop UIs in Android system are generally called as Launcher) of the personal region of the system may be recorded. If it has never set or is the work region application, then one of existing launchers may be randomly selected as a Launcher of the personal region.

According to one example of the disclosure, the work region application installed in the mobile terminal is subjected to a reinforcement treatment. For example, the operating system in the mobile terminal is Android. This is because most of applications of Android are developed by JAVA language. Since finally compiled result of an application developed by JAVA is not a binary file, some information (for example, a password and a section of codes) is easily obtained by decompiling files.

Content of a class.dex file of the work region application is changed. For example, some of attribute names are changed and content thereof is encrypted in appropriate algorithms. When an apk of the work region application runs, the content may be dynamically decrypted to be restored. When class.dex is changed, it should be kept in an inherent format of the dex file. In the process of re-packing the work region application, some configuration information (for example, package; name attribute of application, service and provider; and authorities attribute of provider) inside overall configuration file known as AndroidManifest.xml in Android application is modified, and some reference in .smali file corresponding to above attributes is modified.

By the reinforcement treatment performed on the work region application installed in the mobile terminal, it is possible to prevent reversing by others to obtain key information such as key code system. In the meanwhile, the reinforcement may increase a function of data encryption for the program, improving the security coefficient.

According to one example of the disclosure, the third party software, when running, sometimes requires to invoke the work region application, such as WordPad, email client or some other applications. Since the data files stored in the database of work region space are save with encryption processing, the work region application may provide a compiled so file, so as to complete encryption and decryption treatments on the content of class.dex file via the so file.

Moreover, by writing codes into the third party application, the third party application may invoke the so file when apk initialization. It may be ensured that running time of so library is earlier than a time when the third party application reads and writes files. Therefore, the class.dex file is prevented from becoming a “half encrypted state” to result in a corrupted file so that the function of business and private region separation cannot be completed. When the third party application is running, all file operations of the third party application are blocked in the so library provided by the work region application, thereby completing the encryption and the function of business and private region separation.

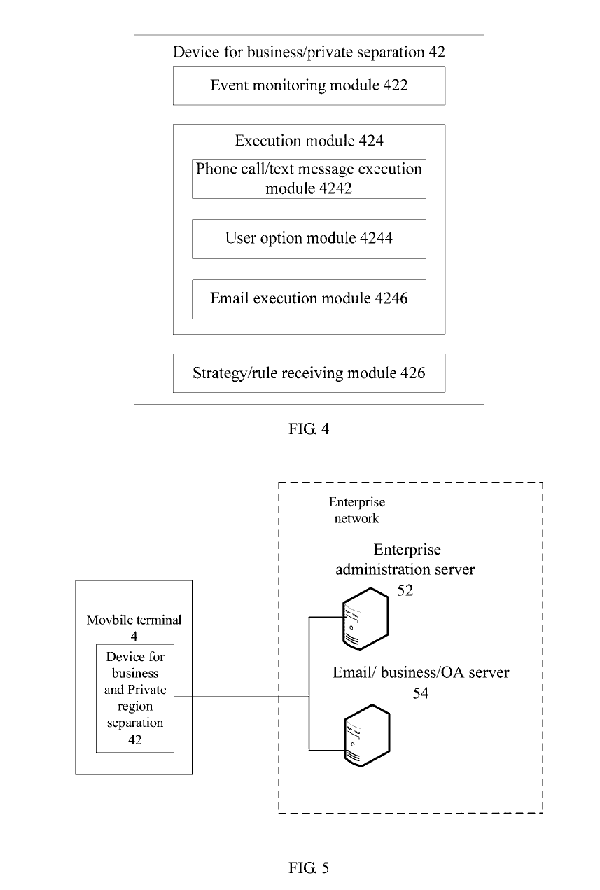

FIG. 4 is a schematic diagram of a device for business and private region separation according to an embodiment of the disclosure. As shown in FIG. 4, the device for business and private region separation 42 may include: an event monitoring module 422 and an execution module 424.

The event monitoring module 422 is configured to monitor a system event of a mobile terminal and determine whether the system event satisfies a preset work region rule. The execution module 424 is configured to, when the system event satisfies the work region rule (for example, the work region rule could be as follows: whether contacts of phone call and text message, and key words of email and text message are stored in the database of work region), execute an operation corresponding to the system event in a work region space, encrypt and store data corresponding to the operation in the database of work region space.

According to one example of the disclosure, the system event may include: a phone call event and a text message event.

The execution module 424 may include a phone call-text message execution module 4242, a user option module 4244 and an email execution module 4246.

The phone call-text message execution module 4242 is configured such that, when it is determined that a phone number of a calling party or called party in a phone call event, or a phone number of a sender or recipient in a text message event is stored in the database of work region space, the system event satisfies the work region rule; and a record in the phone call event or a text message in the text message event is encrypted and stored in the database of work region space.

The phone call-text message execution module 4242 is further configured to delete the record in the phone call event from a phone call record of the mobile terminal, or delete the text message in the text message event from a text message record of the mobile terminal.

The phone call-text message execution module 4242 is further configured to block the record in the phone call event from entering a phone call record of the mobile terminal, or block the text message in the text message event from entering a text message record of the mobile terminal.

The user option module 4244 is configured to provide an option interface of phone call such that the user selects whether to delete a phone call record of the mobile terminal when the phone number of a calling party or called party of an incoming call is stored in the database of work region space.

The user option module 4244 is further configured to provide an option interface of email rule, such that the user sets to receive an email account only in the work region or using a work region application and stores the email account in the database of work region space.

The email execution module 4246 is configured such that, when the system event is determined to be receiving-email and an email account of a sender is stored in the database of work region space, the system event satisfies the work region rule; and content of the email and downloaded email attachment are encrypted and then stored in the database of work region space.

The execution module 424 is further configured to, after a password inputted by the user is successfully verified and when the user enters the work region to view the phone call records, the text messages, the emails or the email attachments, decrypt the record in the phone call event, the text message in the text message event, and the email in the email event or the email attachment in the email event stored in the database of work region space; and when the user is determined to finish viewing, delete temporary files of the phone call record, the text message, the email or the email attachment generated by the encryption.

The execution module 424 is further configured to, if the user views the data stored in the database of work region via a browser, when the user closes the browser, clean up cache of the browser.

The user option module 4244 is further configured to allow a work region application to be operated in the mobile terminal and enter the work region, provide the option interface of contacts for the user, receive work-related contacts selected by the user from contacts of mobile terminal address book, and store the work-related contacts selected by the user in the database of work region space.

A strategy and rule receiving module 426 is configured to receive a work region strategy and rule sent from a business administration platform and store the work region strategy and rule in the database of work region. For example, the work region rule could be as follows: whether contacts of phone call and text message, and key words of email and text message are stored in the database of work region. The work region strategy may include: when the contacts of phone calls or text messages are given contacts of work region, encrypting and storing the phone call records and text messages, and deleting records from the mobile terminal; when the user views information in the work region, requiring of a password authentication; periodically downloading and updating the work region application; periodically killing viruses; and setting priority of the work region application, for example.

FIG. 5 is a schematic diagram of an interaction with enterprise network information by the device for business and private region separation according to the embodiment of the disclosure. As shown in FIG. 5, the mobile terminal 4 is provided with the device for business and private region separation 42, which could be implemented in many manners such as integrated circuit, plug-in and application.

The device for business and private region separation 42 may receive the work region strategy and rule sent from the enterprise administration platform (server) 52 and may store the work region strategy and rule in the database of work region. By the enterprise administration platform (server) 52 disposed inside the enterprise network, the administrator may easily complete mobile terminal management, strategy management issuance and enterprise application management, thereby reducing the management complexity and saving IT human input.

By an email, business and OA server 54 disposed inside the enterprise network, for example, it is possible to complete the issuance of statement reports and official documents of the mobile terminal 4. The device for business and private region separation 42 may communicate with the email, business and OA server 54 to perform business operations, for example, inclusive of receiving/sending text messages, writing emails or downloading official documents. The data such as files, pictures, emails and text messages can be encrypted and stored in the database of work region space.

The method and device for business and private region separation according to the disclosure can be not only provided in the mobile terminal but also applied in a personal terminal such as personal PC and tablet computer.

The method and device for business and private region separation according to the disclosure can establish a safe and independent work region in the mobile terminal to store all the work data (i.e., enterprise application and data) in a protected security region without interfering with use experience of individual application of staff. An individual application cannot visit the enterprise data, preventing the enterprise data from an illegal access by the individual application. Not only could the enterprise data be completely separated from individual data so as to allow the IT department to better protect the enterprise application and data, but also the staff can be provided with undifferentiated personal application experience, achieving a “one machine dual purposes” effect.

The method and system in the disclosure may be implemented in many ways. For example, the method and system in the disclosure may be implemented by software, hardware, firmware or any combination of software, hardware and firmware. The sequence of steps configured as the method is provided for an illustrative purpose. The steps of the method according to the disclosure are not limited to the specific sequence as described above, unless otherwise specified. Additionally, in some examples, the disclosure may be embodied as program recorded in a recording medium, comprising machine-readable instructions configured to implement the method according to the disclosure. Therefore, the disclosure is also intended to encompass the recording medium configured to store the program for executing the method according to the disclosure.

The description of the disclosure is provided for the illustrative and descriptive purpose, rather than being exhaustive or limiting the disclosure thereto. Many modifications and variants are obvious for a person having ordinary skill in the art. The embodiments are selected and described such that principles and practical applications of the disclosure could be better explained and the person having ordinary skill in the art can understand the disclosure to conceive a variety of embodiments with modifications suitable to special purposes.

Each of components according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the components in the device for business and private region separation according to the embodiments of the disclosure. The disclosure may further be implemented as apparatus or device program (for example, computer program and computer program product) for executing some or all of the methods as described herein. Such program for implementing the disclosure may be stored in the computer readable medium, or have a form of one or more signals. Such a signal may be downloaded from the Internet websites, or be provided in carrier, or be provided in other manners.

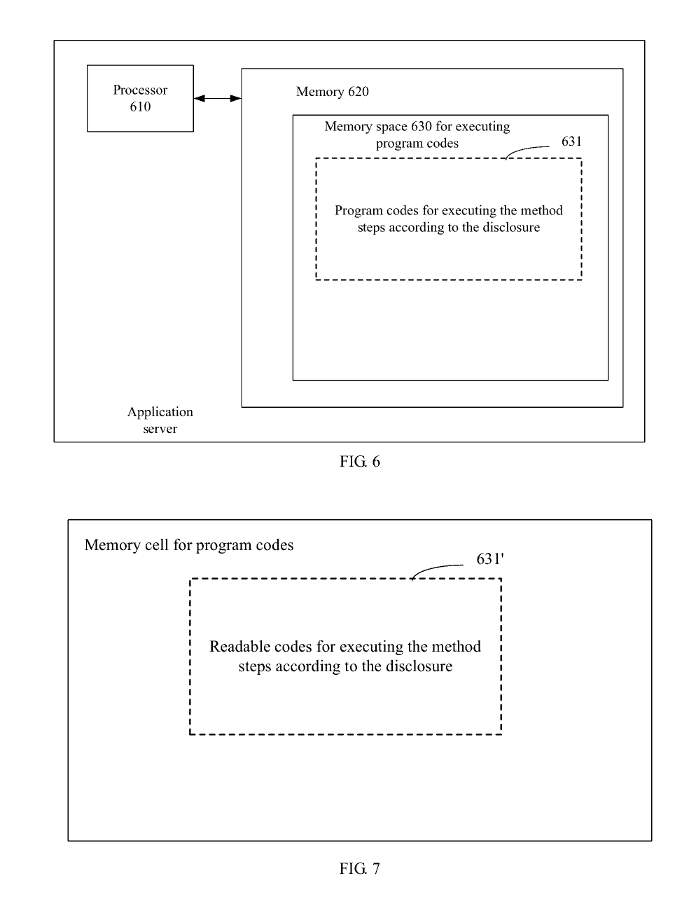

For example, FIG. 6 illustrates a computing device which may complete the method for business and private region separation according to the disclosure. Traditionally, the device includes a processor 610 and a computer program product or a computer readable medium in form of a memory 620. The memory 620 could be electronic memories such as flash memory, EEPROM (Electrically Erasable Programmable Read-Only Memory), EPROM, hard disk or ROM. The memory 620 has a memory space 630 for executing program codes 631 of any steps in the above methods. For example, the memory space 630 for program codes may include respective program codes 631 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 7. The memory cells may be provided with memory sections, memory spaces, etc., similar to the memory 620 of the intelligent electronic apparatus as shown in FIG. 6. The program codes may be compressed for example in an appropriate form. Usually, the memory cell includes a program 631′ for executing the method steps according to the disclosure, which could be codes readable for example by processors 610. When these codes are operated on the intelligent electronic apparatus, the communication device may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

1. A method for business and private region separation, comprising:
monitoring a system event of a mobile terminal and determining whether the system event satisfies a preset work region rule; and
when the system event satisfies the work region rule, executing an operation corresponding to the system event in a work region space, and encrypting and storing data corresponding to the operation in a database of the work region space.

2. The method according to claim 1, wherein
the system event comprises a phone call event and a text message event;
when it is determined that a phone number of a calling party or called party in the phone call event, or a phone number of a sender or recipient in the text message event is stored in the database of work region space, the system event satisfies the work region rule; and
the encrypting and storing data corresponding to the operation in a database of the work region space comprises: encrypting a record in the phone call event or a text message in the text message event, and storing the record in the phone call event or the text message in the text message event in the database of work region space.

3. The method according to claim 2, wherein after the step of storing the record in the phone call event or the text message in the text message event in the database of work region space, the method further comprises:
deleting the record in the phone call event from a phone call record of the mobile terminal, or deleting the text message in the text message event from a text message record of the mobile terminal.

4. The method according to claim 2, wherein before the step of storing the record in the phone call event or the text message in the text message event in the database of work region space, the method further comprises:
blocking the record in the phone call event from entering a phone call record of the mobile terminal, or blocking the text message in the text message event from entering a text message record of the mobile terminal.

5. The method according to claim 2, wherein before the step of deleting the record in the phone call event from a phone call record of the mobile terminal, the method further comprises:
providing an option interface of phone call such that the user selects whether to delete a phone call record of the mobile terminal when the phone number of a calling party or called party of an incoming call is stored in the database of work region space, and executing a step of deleting the record in the phone call event after the user selects to delete it.

6. The method according to claim 1, wherein the method further comprises:
providing an option interface of email rule, such that the user sets to receive an email account only in the work region or using a work region application and storing the email account in the database of work region space;
when the system event is determined to be receiving-email and an email account of a sender is stored in the database of work region space, the system event satisfies the work region rule;
the encrypting and storing data corresponding to the operation in a database of the work region space, comprises: encrypting content of the email and downloaded email attachment and storing the content of the email and downloaded email attachment in the database of work region space.

7. The method according to claim 2, wherein, after a password inputted by the user is successfully verified and when the user enters the work region to view the phone call records, the text messages, the emails or the email attachments, the method further comprises:
decrypting the record in the phone call event, the text message in the text message event, and the email in the email event or the email attachment in the email event stored in the database of work region space; and
when the user is determined to finish viewing, deleting temporary files of the phone call record, the text message, the email or the email attachment generated by the encryption.

8. The method according to claim 7, wherein the method further comprises:
if the user views the data stored in the database of work region via a browser, when the user closes the browser, cleaning up cache of the browser.

9. The method according to claim 7, wherein the method further comprises:
operating a work region application in the mobile terminal and entering the work region, providing the option interface of contacts for the user, receiving work-related contacts selected by the user from contacts of mobile terminal address book, and storing the work-related contacts selected by the user in the database of work region space; and
receiving a work region strategy and rule sent from a business administration platform and storing the work region strategy and rule in the database of work region.

10. A device for business and private region separation, comprising:
a memory having instructions stored thereon;
a processor configured to execute the instructions to perform operations for business and private region separation, comprising:
monitoring a system event of a mobile terminal and determining whether the system event satisfies a preset work region rule; and
when the system event satisfies the work region rule, executing an operation corresponding to the system event in a work region space, encrypting and storing data corresponding to the operation in the database of work region space.

11. The device according to claim 10, wherein:
the system event comprises a phone call event and a text message event;
when it is determined that a phone number of a calling party or called party in a phone call event, or a phone number of a sender or recipient in a text message event is stored in the database of work region space, the system event satisfies the work region rule; and
a record in the phone call event or a text message in the text message event is encrypted and stored in the database of work region space.

12. The device according to claim 11, wherein
the processor is further configured to perform:
deleting the record in the phone call event from a phone call record of the mobile terminal, or deleting the text message in the text message event from a text message record of the mobile terminal.

13. The device according to claim 11, wherein
the processor is further configured to perform:
blocking the record in the phone call event from entering a phone call record of the mobile terminal, or blocking the text message in the text message event from entering a text message record of the mobile terminal.

14. The device according to claim 11, wherein when the system event satisfies the work region rule, executing an operation corresponding to the system event in a work region space, encrypting and storing data corresponding to the operation in the database of work region space further comprises:
providing an option interface of phone call such that the user selects whether to delete a phone call record of the mobile terminal when the phone number of a calling party or called party of an incoming call is stored in the database of work region space.

15. The device according to claim 6, wherein when the system event satisfies the work region rule, executing an operation corresponding to the system event in a work region space, encrypting and storing data corresponding to the operation in the database of work region space further comprises:
providing an option interface of email rule, such that the user sets to receive an email account only in the work region or using a work region application and storing the email account in the database of work region space; and
when the system event is determined to be receiving-email and an email account of a sender is stored in the database of work region space, the system event satisfies the work region rule; and content of the email and downloaded email attachment are encrypted and then stored in the database of work region space.

16. The device according to claim 11, wherein
when the system event satisfies the work region rule, executing an operation corresponding to the system event in a work region space, encrypting and storing data corresponding to the operation in the database of work region space comprises:
after a password inputted by the user is successfully verified and when the user enters the work region to view the phone call records, the text messages, the emails or the email attachments, decrypting the record in the phone call event, the text message in the text message event, and the email in the email event or the email attachment in the email event stored in the database of work region space; and when the user is determined to finish viewing, deleting temporary files of the phone call record, the text message, the email or the email attachment generated by the encryption.

17. The device according to claim 11, wherein
when the system event satisfies the work region rule, executing an operation corresponding to the system event in a work region space, encrypting and storing data corresponding to the operation in the database of work region space comprises:
when the user views the data stored in the database of work region via a browser and when the user closes the browser, cleaning up cache of the browser.

18. The device according to claim 16, wherein the processor is further configured to perform:
allowing a work region application to be operated in the mobile terminal and enter the work region, provide providing the option interface of contacts for the user, receiving work-related contacts selected by the user from contacts of mobile terminal address book, and storing the work-related contacts selected by the user in the database of work region space; and
receiving a work region strategy and rule sent from a business administration platform and storing the work region strategy and rule in the database of work region.

19. (canceled)

20. A readable medium, having computer program stored thereon that, when executed by one or more processors of a computing device, cause the computing device to perform:
monitoring a system event of a mobile terminal and determining whether the system event satisfies a preset work region rule; and
when the system event satisfies the work region rule, executing an operation corresponding to the system event in a work region space, and encrypting and storing data corresponding to the operation in a database of the work region space.
